(19) United States
(12) Patent Application Publication
(10) Pub. No.: US 2016/0133913 A1
(43) Pub. Date: May 12, 2016

(54) SECONDARY BATTERY

(71) Applicant: SAMSUNG SDI CO., LTD., Yongin-si (KR)

(72) Inventors: Heeyoun WON, Yongin-si (KR); Daeyon MOON, Yongin-si (KR)

(21) Appl. No.: 14/725,024

(22) Filed: May 29, 2015

(30) Foreign Application Priority Data
Nov. 12, 2014 (KR) 10-2014-0157329

(51) Int. Cl. H01M 2/34

(52) U.S. Cl. CPC H01M 2/348; H01M 2200/10

(57) ABSTRACT

Provided is a secondary battery including an electrode assembly; a cap plate sealing the electrode assembly; an electrode pin electrically connected to the electrode assembly and on the cap plate; an insulating gasket between the cap plate and the electrode pin; and a temperature protection device on the cap plate and having one end directly connected to the electrode pin.

### CROSS-REFERENCE TO RELATED APPLICATION

Korean Patent Application No. 10-2014-0157329, filed on Nov. 12, 2014, in the Korean Intellectual Property Office, and entitled: “Secondary Battery,” is incorporated by reference herein in its entirety.

### BACKGROUND

1. Field

One or more exemplary embodiments relate to a secondary battery.

2. Description of the Related Art

With the development of wireless Internet and communication technologies, supply of portable computers operable by using a battery without having to use a power supply device may increase. Portable computers may be small and easy to carry, and may have excellent mobility. Portable computers may be used for business uses or personal uses. For portable computers to be used in various places irrespective of a power supply device, portable computers may include one or more secondary batteries.

### SUMMARY

Embodiments may be realized by providing a secondary battery, including an electrode assembly; a cap plate sealing the electrode assembly; an electrode pin electrically connected to the electrode assembly and on the cap plate; an insulating gasket between the cap plate and the electrode pin; and a temperature protection device on the cap plate and having one end directly connected to the electrode pin.

The temperature protection device may include a transmitter; a first lead terminal extending from one end of the transmitter and electrically connected to the electrode pin; and a second lead terminal extending from another end of the transmitter and connected to a first electrode tab.

The first lead terminal may be on the electrode pin and may overlap at least a part of the electrode pin.

An area of the first lead terminal may be smaller than an area of the electrode pin.

The first lead terminal may be partially encompassed by the electrode pin in a plane of the electrode pin.

The first lead terminal may be welded and electrically connected to the electrode pin.

The electrode pin may include a first end portion contacting the first lead terminal and a second end portion not contacting the first lead terminal, and the first and second end portions may be welded, e.g., by welding rods, on the first and second portions, respectively.

The secondary battery may further include a second electrode tab spaced apart from the electrode pin and on the cap plate and having a different polarity from the first electrode tab.

The secondary battery may further include an insulating member between the temperature protection device and the cap plate.

The transmitter and the second lead terminal may be on the insulating member.

### BRIEF DESCRIPTION OF THE DRAWINGS

Features will become apparent to those of skill in the art by describing in detail exemplary embodiments with reference to the attached drawings in which:

FIG. 1 illustrates a schematic perspective view schematically of a secondary battery according to an exemplary embodiment;

FIG. 2 illustrates an exploded perspective view of the secondary battery of FIG. 1;

FIG. 3 illustrates a view of a protection circuit module and a secondary battery, which are combined with each other, according to an exemplary embodiment;

FIG. 4 illustrates a perspective view of some components of the secondary battery of FIG. 2; and

FIGS. 5 and 6 illustrate top and side views of the some components of FIG. 4, respectively.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In drawings, like reference numerals refer to like elements throughout and overlapping descriptions shall not be repeated.

While such terms as “first”, “second”, etc., may be used to describe various components, such components must not be limited to the above terms. The above terms are used only to distinguish one component from another.

An expression used in the singular encompasses the expression of the plural, unless it has a clearly different meaning in the context.

In the present specification, it is to be understood that the terms such as “including” or “having,” etc., are intended to indicate the existence of the features or components, and are not intended to preclude the possibility that one or more other features or components may exist or may be added.

It will be understood that when a component or layer is referred to as being “on” another component or layer, the component or layer can be directly on another component or layer or intervening component or layers. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present.

In drawings, for convenience of description, sizes of components may be exaggerated for clarity. For example, since sizes and thicknesses of components in drawings are arbitrarily shown for convenience of description, the sizes and thicknesses are not limited thereto.

In drawings, an X direction indicates a length direction, a Y direction that is perpendicular to the X direction indicates a thickness direction, and a Z direction that is perpendicular to the X and Y directions indicates a height direction.

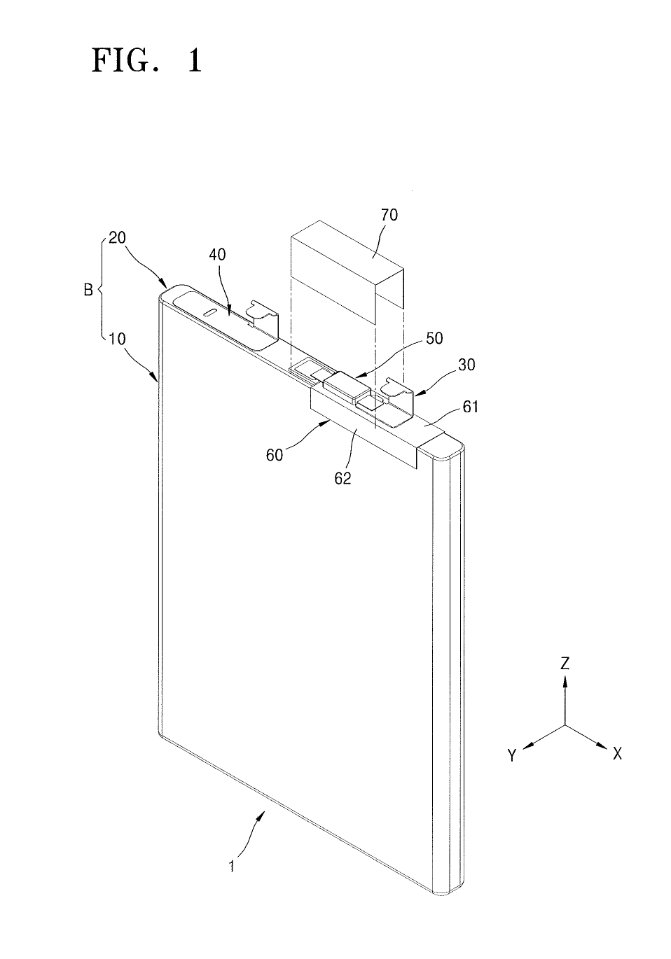

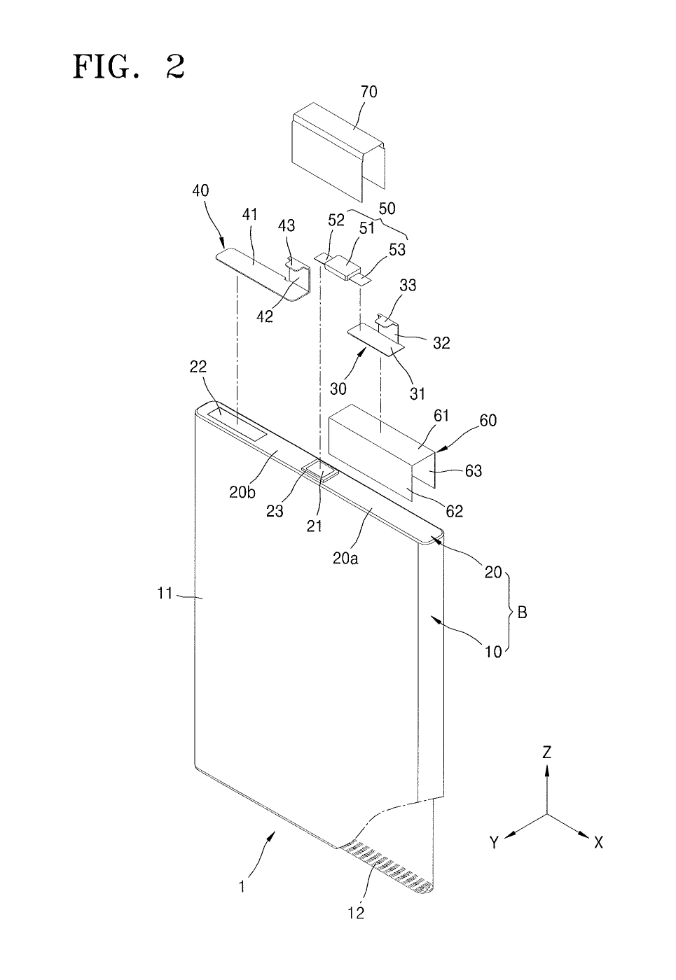

FIG. 1 illustrates a schematic perspective view of a secondary battery 1 according to an exemplary embodiment, and FIG. 2 illustrates an exploded perspective view of the secondary battery 1 of FIG. 1. For convenience of understanding, in FIG. 2, a part of a can 10 is opened such that an electrode assembly 12 is exposed.

Referring to FIGS. 1 and 2, the secondary battery 1 according to an exemplary embodiment may include a bare cell B, a first electrode tab 30, a second electrode tab 40, an insulating member 60, and a fixing member 70.

The bare cell B may be a rechargeable secondary battery, and may include a lithium-ion battery. The bare cell B may have an approximately hexahedral prismatic shape. The bare cell B may include the can 10 including an opening, the electrode assembly 12 accommodated inside the can 10 through the opening, a cap plate 20 sealing the opening of the can 10, and an electrode pin 21 formed on the cap plate 20.

The can 10 may have an approximately hexahedral shape having one opened side, and may be formed of a metallic material to secure strength. For example, the can 10 may be formed of aluminum or an aluminum alloy. After the electrode assembly 12 is inserted into the can 10 through the opening, the opening may be sealed by the cap plate 20. Like the can 10, the cap plate 20 may be formed of a metallic material, such as aluminum or an aluminum alloy. A region where the cap plate 20 and the can 10 contact each other may be combined via laser welding, and internal air-tightness may be maintained.

The electrode assembly 12 may include first and second electrode plates on which electrode active materials are coated, and a separator disposed between the first and second electrode plates. The first and second electrode plates may have different polarities. The electrode assembly 12 may be manufactured by sequentially stacking the first electrode plate, the separator, and the second electrode plate, and then rolling them in a jelly roll shape.

In the current embodiment, the electrode assembly 12 has a jelly roll shape. In another embodiment, the electrode assembly 12 may be manufactured by sequentially stacking the first electrode plate, the separator, and the second electrode plate.

The electrode pin 21 may be formed on the cap plate 20. The electrode pin 21 may protrude in a direction away from the cap plate 20.

The first electrode plate may be electrically connected to the electrode pin 21, and the second electrode plate may be electrically connected to the cap plate 20. Since the first and second electrode plates may have different polarities, the electrode pin 21 and the cap plate 20 may also have different polarities. For example, the electrode pin 21 may have a negative pole and the cap plate 20 may have a positive pole. An insulating gasket 23 may be disposed between the electrode pin 21 and the cap plate 20 to prevent a short circuit between the electrode pin 21 and the cap plate 20.

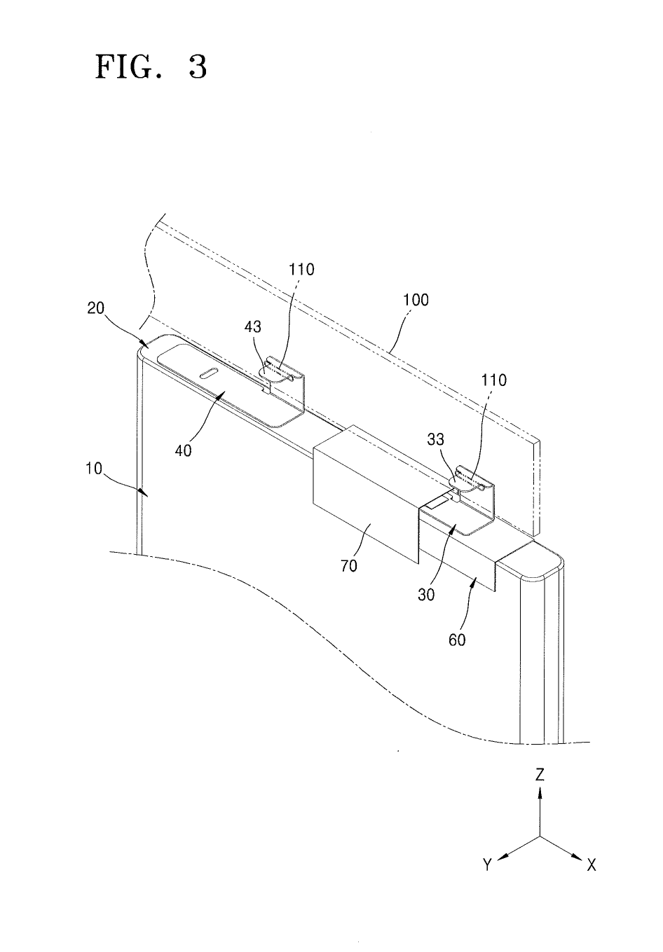

FIG. 3 illustrates a view of a protection circuit module 100 and the secondary battery 1, which are combined with each other, according to an exemplary embodiment.

Referring to FIG. 3, the first and second electrode tabs 30 and 40 may be disposed on a first surface of the bare cell B, for example, on the cap plate 20, and may electrically connect the secondary battery 1 to the protection circuit module 100. The secondary battery 1 may be electrically connected to the protection circuit module 100 as third regions 33 and 43 of the first and second electrode tabs 30 and 40 may be inserted into and welded to a hole 110 formed in the protection circuit module 100.

The protection circuit module 100 may be electrically connected to the bare cell B, charging and discharging of the bare cell B may be controlled, and overheating or an explosion generated, for example, due to overcharging, over-discharging, or an over-current, may be prevented.

Referring back to FIGS. 1 and 2, the first electrode tab 30 may be disposed on a partial region (a first region 20a) of the cap plate 20, and the second electrode tab 40 may be disposed on another region (a second region 20b) of the cap plate 20. According to an embodiment, the first and second electrode tabs 30 and 40 may be disposed opposite to each other around the electrode pin 21.

The first electrode tab 30 may be disposed on the insulating member 60 provided in the first region 20a of the cap plate 20, and electrically connected to the electrode pin 21 through a temperature protection device 50. The second electrode tab 40 may be electrically connected to the cap plate 20 by directly contacting and being welded to the second region 20b of the cap plate 20.

The first electrode tab 30 may include a first region 31 connected to the temperature protection device 50 and parallel to the cap plate 20, a second region 32 curved with respect to the first region 31, and the third region curved with respect to the second region 32 and parallel to the first region 31.

The second electrode tab 40 may include a first region 41 parallel to the cap plate 20, a second region 42 curved with respect to the first region 41, and the third region 43 curved with respect to the second region 42 and parallel to the first region 41.

The second electrode tab 40 and the cap plate 20 may be formed of different materials. For example, the cap plate 20 may be formed of aluminum or an aluminum alloy, and the second electrode tab 40 may be formed of nickel. A combining piece 22 may be further disposed on the cap plate 20 to increase weldability between the second electrode tab 40 and the cap plate 20, which may be formed of two types of materials. The combining piece 22 may be formed of a different material from the cap plate 20, for example, the same material as the second electrode tab 40.

Since the first electrode tab 30 is electrically connected to the electrode pin 21, and the second electrode tab 40 is electrically connected to the cap plate 20, the first and second electrode tabs 30 and 40 may have different polarities. For example, the first electrode tab 30 may have a negative pole and the second electrode tab 40 may have a positive pole.

The temperature protection device 50 may block a current flow when the bare cell B is over-heated up to a temperature equal to or higher than a certain temperature, and the bare cell B may be prevented from igniting or exploding.

The temperature protection device 50 may include a transmitter 51, and first and second lead terminals 52 and 53 that are respectively formed on two sides of the transmitter 51. The transmitter 51 may include a base device and a cover surrounding the base device.

The base device may be a conducting and insulating reversible device according to a temperature, and, for example, may be formed by including a polymer positive temperature coefficient (PTC) obtained by dispersing conductive particles, such as metal particles or carbon particles, in crystalline polymer, a fuse, a current blocking device, or a bi-metal.

The cover may surround an outer region of the base device to protect the base device. The cover may expose a bottom surface of the base device, and the base device may contact the insulating member 60.

The first and second lead terminals 52 and 53 may be electrically connected to the base device, and may extend in opposite directions through the cover. The first lead terminal 52 may contact the electrode pin 21 and the second lead terminal 53 may contact the first electrode tab 30.

The first and second lead terminals 52 and 53 may be formed at different heights from the transmitter 51. A height of the electrode pin 21 connected to the first lead terminal 52 and a height of the first electrode tab 30 connected to the second lead terminal 53 may be different from each other, and a height of a surface where the first lead terminal 52 and the electrode pin 21 contact each other and a height of a surface where the second lead terminal 53 and the first electrode tab 30 contact each other may be different from each other.

When the first and second lead terminals 52 and 53 have different heights, the transmitter 51 may be closely adhered to the insulating member 60 and the temperature protection device 50 may not be detached from the cap plate 20, and a temperature may be accurately measured.

Since the second electrode tab 40 disposed on the cap plate 20 may have the same polarity as the cap plate 20, the second electrode tab 40 and the cap plate 20 may not cause a short-circuit. Since the first electrode tab 30 disposed on the cap plate 20 may have a different polarity from the cap plate 20, the insulating member 60 may be disposed between the first electrode tab 30 and the cap plate 20 to prevent the first electrode tab 30 and the cap plate 20 from causing a short-circuit.

The insulating member 60 may be adhered on an outer surface of the bare cell B, and a short circuit between the first electrode tab 30 and the outer surface of the bare cell B may be prevented.

As described above, the cap plate 20 may be welded to and combined with the can 10. Like the cap plate 20, the can 10 may be formed of a conductive metal, and the can 10 may have the same polarity as the cap plate 20.

Since the outer surface of the bare cell B excluding the electrode pin 21, and the first electrode tab 30 may have different polarities, the insulating member 60 may be manufactured to have a wide area, and a short circuit between the first electrode tab 30 and the cap plate 20 and a short circuit between the first electrode tab 30 and an outer surface of the can 10 may be prevented.

The insulating member 60 may cover some of three outer surfaces of the bare cell B. For example, the insulating member 60 may include a first region 61 covering the first region 20a of the cap plate 20, which may be a first surface of the bare cell B, a second region 62 perpendicular to the first region 61 and covering a part of a second surface 11 of the bare cell B, and a third region 63 perpendicular to the first region 61 and covering a part of a third surface of the bare cell B. A surface of the insulating member 60, which faces the bare cell B, may be adhesive and adhered to the outer surface of the bare cell B, as shown in FIG. 2

For example, the insulating member 60 may be formed of a thin polyethyleneterephthalate (PET) film.

The fixing member 70 may cover the first electrode tab 30 and the temperature protection device 50 to prevent the first electrode tab 30 and the temperature protection device 50 from being separated or detached from the bare cell B.

The temperature protection device 50 may be combined with the bare cell B as the first lead terminal 52 may be directly welded to the electrode pin 21. Since only the first lead terminal 52 may be welded and the second lead terminal 53 may not be connected to the first electrode tab 30, the temperature protection device 50 may not be fixed. When the second lead terminal 53 is not fixed, the temperature protection device 50 may be detached from the bare cell B or the temperature protection device 50 may move to cause a short-circuit with the outer surface of the bare cell B.

Even when the second lead terminal 53 is connected to the first electrode tab 30, the first electrode tab 30 may not be fixed to the hole 110 formed in the protection circuit module 100, and first electrode tab 30 may be detached from the bare cell B or the first electrode tab 30 may move to cause a short-circuit with the outer surface of the bare cell B.

Since the fixing member 70 may be disposed to cover the first electrode tab 30 or the temperature protection device 50, the first electrode tab 30 or the temperature protection device 50 may be prevented from being detached or causing a short-circuit.

The fixing member 70 may be formed in a similar manner as the insulating member 60. For example, the fixing member 70 may include a portion covering the first electrode tab 30 and two end portions perpendicularly curved with respect to the portion. The fixing member 70 may be a molded product or an adhesive tape. When the fixing member 70 is an adhesive tape, a thickness of the secondary battery 1 may be prevented from being increased.

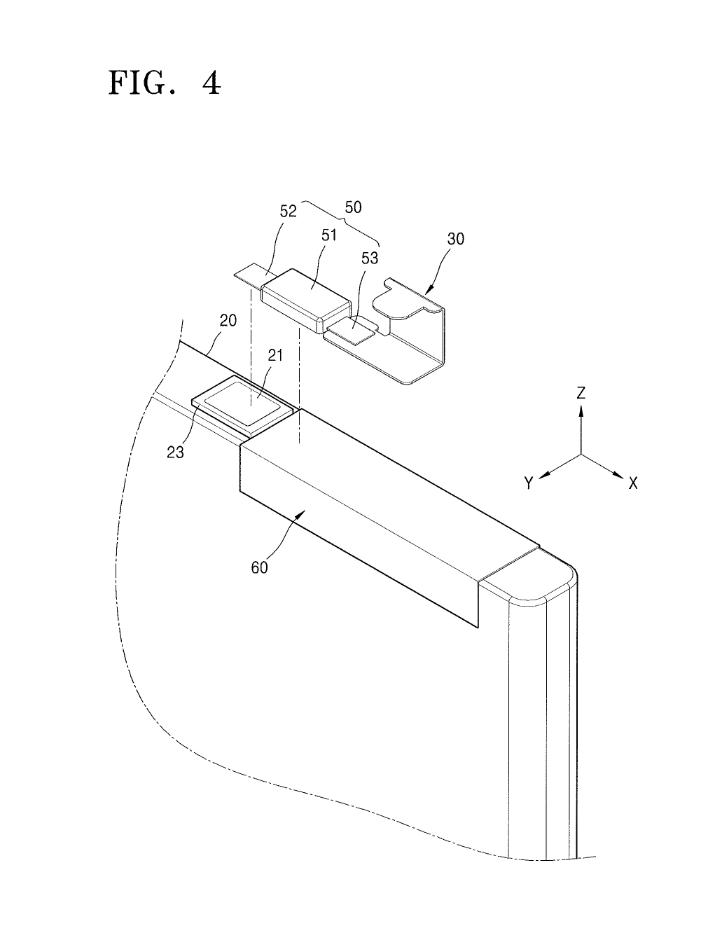

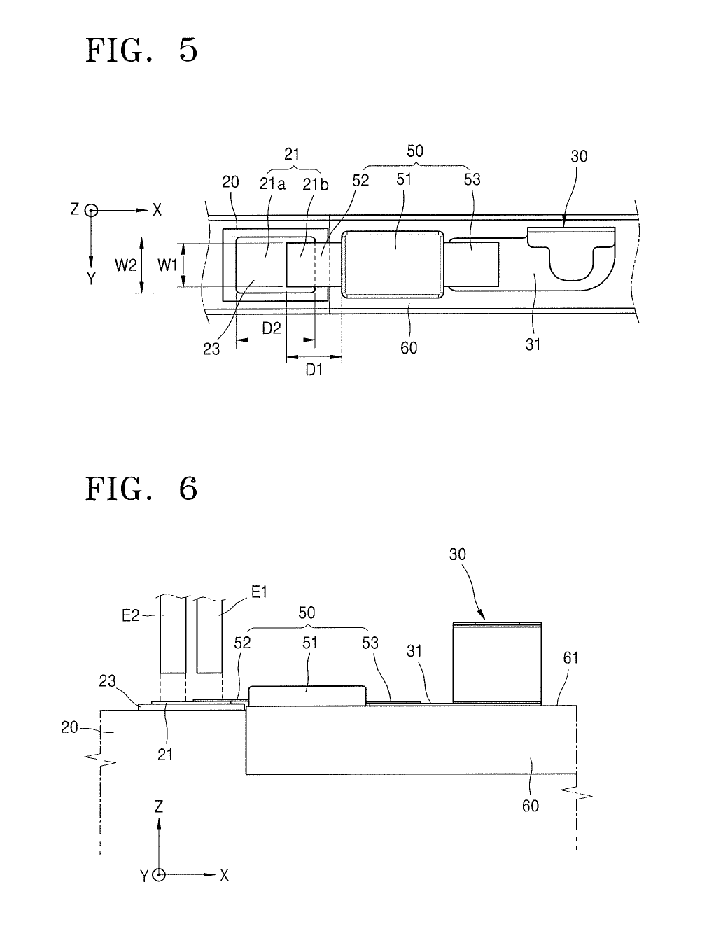

FIG. 4 illustrates a perspective view of some components of the secondary battery 1 of FIG. 2, and FIGS. 5 and 6 illustrate top and side views of the some components of FIG. 4, respectively.

Connection and arrangement of the electrode pin 21 and the temperature protection device 50 will now be described with reference to FIGS. 4 through 6.

The secondary battery 1 may include the electrode assembly 12 of FIG. 2, the cap plate 20 for sealing the electrode assembly 12, and the electrode pin 21 electrically connected to the electrode assembly 12 and assembled on the cap plate 20 through the insulating gasket 23, and may further include the first lead terminal 52 combined on the electrode pin 21.

For example, the electrode pin 21 may be assembled on the cap plate 20 through the insulating gasket 23, and the insulating gasket 23 may be disposed between the electrode pin 21 and the cap plate 20, which may have different polarities, and the electrode pin 21 and the cap plate 20 may be insulated from each other. The electrode pin 21 and the first lead terminal 52 may be directly connected to each other. The electrode pin 21 and the first lead terminal 52 may be electrically connected by being combined with each other via welding.

The electrode pin 21 has a planar configuration and extends in a horizontal plane. The first lead terminal 52 may be disposed on the electrode pin 21 to overlap at least a part of the electrode pin 21. The first lead terminal 52 may be disposed on the electrode pin 21 to be included in the electrode pin 21. A size of an area of the first lead terminal 52 may be smaller than that of the electrode pin 21. Also, a width of the first lead terminal 52 is smaller than a width of the electrode pin 21. Hence the first lead terminal 52 is partially encompassed by the electrode pin 21 in the plane of the electrode pin 21, i.e., in plan view. (See FIG. 5.)

D1 denotes a length of the first lead terminal 52 in a length direction (hereinafter, referred to as a first direction) of the secondary battery, and D2 denotes a length of the electrode pin 21 in the first direction. D1 may be smaller than D2, and the first lead terminal 52 may cover a part of the electrode pin 21.

W1 denotes a width of the first lead terminal 52 provided in a direction perpendicular to the first direction, and W2 denotes a width of the electrode pin 21. W1 may be smaller than W2, and the first lead terminal 52 may cover a part of the electrode pin 21.

When a size of the first lead terminal 52 is smaller than that of the electrode pin 21, efficiency of a welding process may increase. To electrically connect the first lead terminal 52 to the electrode pin 21, the first lead terminal 52 may be welded to the electrode pin 21 by using a welding rod. If the size of the first lead terminal 52 is increased, a welding amount may increase, a welding time may increase, and productivity of the secondary battery 1 may decrease. Energy consumption may increase as the size of the first lead terminal 52 to be welded is increased.

The electrode pin 21 may be divided into a first end portion 21a contacting the first lead terminal 52, and a second end portion 21b not contacting the first lead terminal 52. A size of the first end portion 21a may be smaller than that of the second end portion 21b.

The first lead terminal 52 and the electrode pin 21 may be connected to each other via welding. During a welding process, the first lead terminal 52 and the electrode pin 21 may be combined with, e.g., connected to, each other by using a plurality of welding rods. First and second welding rods E1 and E2 may be respectively disposed at the first and second end portions 21a and 21b to weld the first lead terminal 52 and the electrode pin 21.

The first welding rod E1 may be disposed on the first end portion 21a, and the second welding rod E2 may be disposed on the second end portion 21b. When the first and second welding rods E1 and E2 are simultaneously used for welding, a part of the first lead terminal 52 at the first end portion 21a and a part of the electrode pin 21 at the second end portion 21b are simultaneously melted, and the electrode pin 21 and the first lead terminal 52 may be strongly connected to each other. Since the part of the first lead terminal 52 at the first end portion 21a and the part of the electrode pin 21 at the second end portion 21b are simultaneously melted, a time of welding the temperature protection device 50 and the electrode pin 21 may be reduced.

A temperature of the secondary battery 1 may be accurately sensed as the temperature protection device 50 may be directly connected to the electrode pin 21. When a distance between the temperature protection device 50 and the electrode pin 21 is increased, resistance may increase, and it may be difficult to accurately measure the temperature. When the temperature protection device 50 is directly connected to the electrode pin 21, a distance of a current moving from the electrode pin 21 to the transmitter 51 of the temperature protection device 50 may be decreased, and an internal temperature of the bare cell B may be accurately measured.

The secondary battery 1 may be slim and compact as the temperature protection device 50 may be directly connected to the electrode pin 21. When a terminal (tab) is additionally used to connect the temperature protection device 50 and the electrode pin 21, a size of the secondary battery 1 may increase. Since consumers' needs for downsizing a secondary battery may be increasing to increase utilization of spaces of electronic devices, the size of the secondary battery 1 according to an exemplary embodiment may be decreased as the temperature protection device 50 may be directly connected to the electrode pin 21. Production costs may be reduced since an additional terminal (tap) need not be used.

As described above, according to one or more exemplary embodiments, a battery pack that may have high assemblability and a thin thickness may be provided.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly;
a cap plate sealing the electrode assembly;
an electrode pin electrically connected to the electrode assembly and on the cap plate;
an insulating gasket between the cap plate and the electrode pin; and
a temperature protection device on the cap plate and having one end directly connected to the electrode pin.

2. The secondary battery as claimed in claim 1, wherein the temperature protection device includes:
a transmitter;
a first lead terminal extending from one end of the transmitter and electrically connected to the electrode pin; and
a second lead terminal extending from another end of the transmitter and connected to a first electrode tab.

3. The secondary battery as claimed in claim 2, wherein the first lead terminal is on the electrode pin and overlaps at least a part of the electrode pin.

4. The secondary battery as claimed in claim 2, wherein an area of the first lead terminal is smaller than an area of the electrode pin.

5. The secondary battery as claimed in claim 2, wherein the first lead terminal is partially encompassed by the electrode pin in a plane of the electrode pin.

6. The secondary battery as claimed in claim 2, wherein the first lead terminal is welded and electrically connected to the electrode pin.

7. The secondary battery as claimed in claim 6, wherein:
the electrode pin includes a first end portion contacting the first lead terminal and a second end portion not contacting the first lead terminal, and
the first and second end portions are welded on the first and second portions, respectively.

8. The secondary battery as claimed in claim 2, further comprising a second electrode tab spaced apart from the electrode pin and on the cap plate and having a different polarity from the first electrode tab.

9. The secondary battery as claimed in claim 2, further comprising an insulating member between the temperature protection device and the cap plate.

10. The secondary battery as claimed in claim 9, wherein the transmitter and the second lead terminal are on the insulating member.
